(19) United States
(12) Patent Application Publication
(10) Pub. No.: US 2024/0306677 A1
(43) Pub. Date: Sep. 19, 2024

(54) UV-A LIGHT DEHYDRATION OF FOODS

(71) Applicant: Luis Javier Bastarrachea Gutiérrez, North Logan, UT (US)

(72) Inventor: Luis Javier Bastarrachea Gutiérrez, North Logan, UT (US)

(73) Assignee: Utah State University, Logan, UT (US)

(21) Appl. No.: 18/606,836

(22) Filed: Mar. 15, 2024

Related U.S. Application Data
(60) Provisional application No. 63/452,280, filed on Mar. 15, 2023.

(51) Int. Cl. A23L 3/54; F26B 3/28

(52) U.S. Cl. CPC A23L 3/54; F26B 3/283

(57) ABSTRACT

An apparatus for UV-A light dehydration of foods includes a light source configured to expose one or more pieces of food in a chamber to ultraviolet (“UV”)-A light to dehydrate the one or more pieces of food. The apparatus has an air flow source configured to provide air flow in the chamber across the one or more pieces of food while being exposed to the UV-A light. Air of the air flow has a relative humidity of less than 50 percent. The apparatus has a controller configured to remove the one or more pieces of food being exposed to the UV-A light and air flow in response to moisture in the one or more pieces of food being below a moisture threshold.

### CROSS-REFERENCES TO RELATED APPLICATIONS

This application claims the benefit of U.S. Provisional Patent Application No. 63/452,280 entitled “UV-A LIGHT DEHYDRATION OF FOODS” and filed on Mar. 15, 2023 for Luis Javier Bastarrachea Gutiérrez, which is incorporated herein by reference.

### GOVERNMENT RIGHTS

This invention was made with government support under Grant No. 1021-09342 awarded by the United States Department of Agriculture. The government has certain rights in the invention.

### FIELD

This invention relates to food dehydration and more particularly relates to dehydration of food using UV-A light.

### BACKGROUND

Food dehydration involves removing moisture from food items. This improves shelf life and reduces the growth of certain microorganisms in and on the food. It can also reduce deterioration in nutritional value and/or aesthetic of the food caused by the moisture. Additionally, certain flavors and aromas that would otherwise degrade in the presence of moisture may be preserved through dehydration. Furthermore, removing water from the food products results in removal of mass and volume, which translates into reduced storage and transportation costs.

### SUMMARY

An apparatus for UV-A light dehydration of foods is disclosed. A system and method also perform the functions of the apparatus. Embodiments of the present disclosure include an apparatus having a light source configured to expose one or more pieces of food in a chamber to ultraviolet (“UV”)-A light to dehydrate the one or more pieces of food. The apparatus also has an air flow source configured to provide air flow in the chamber across the one or more pieces of food while being exposed to the UV-A light, wherein air of the air flow has a relative humidity of less than 50 percent. The apparatus also has a controller configured to remove the one or more pieces of food from being exposed to the UV-A light and air flow in response to moisture in the one or more pieces of food being below a moisture threshold.

Embodiments of the present disclosure include a method including exposing, using a light source, one or more pieces of food in a chamber to ultraviolet UV-A light to dehydrate the one or more pieces of food. The method also includes providing, with an air flow source, air flow across the one or more pieces of food in the chamber while being exposed to the UV-A light, wherein air of the air flow has a relative humidity of less than 50 percent. The method includes removing the one or more pieces of food from being exposed to the UV-A light and air flow in response to moisture in the one or more pieces of food being below a moisture threshold.

Embodiments of the present disclosure include a system having a chamber having a light source including one or more ultraviolet UV-A lights, the chamber comprising an air flow inlet and an air flow outlet. The system also has an air flow source connected to the air flow inlet and/or the air flow outlet. The air flow source includes an air mover positioned to provide air flow to the at least one of the air flow inlet or the air flow outlet, wherein air provided by the air flow source has a relative humidity of less than 50 percent. The system also includes a controller configured to: turn on the light source to expose one or more pieces of food to UV A light from the light source; turn on the air mover to provide air flow across the one or more pieces of food, wherein air exits the first chamber via the air flow outlet; and turn off the light source and the air mover in response to moisture in the one or more pieces of food being below a moisture threshold.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating an embodiment of a system of UV-A light dehydration of food, in accordance with the present disclosure;

FIG. 2 is a schematic diagram illustrating an embodiment of a system of UV-A light dehydration of food with a pump, in accordance with the present disclosure;

FIG. 3 is a schematic diagram illustrating an embodiment of a system of UV-A light dehydration of food with a compressor, in accordance with the present disclosure;

FIG. 4 is a schematic diagram illustrating an embodiment of a system of UV-A light dehydration of food with an air mover, an inner chamber and an outer chamber, in accordance with the present disclosure;

FIG. 5 is a schematic diagram illustrating an embodiment of a system of UV-A light dehydration of food with a shield, in accordance with the present disclosure;

FIG. 6A is an illustration of results of an embodiment of a method of UV-A light dehydration of food depicting moisture content over time, in accordance with the present disclosure;

FIG. 6B is an illustration of results of an embodiment of a method of UV-A light dehydration of food depicting moisture removal over time, in accordance with the present disclosure;

FIG. 7 is an illustration of results of an embodiment of a method of UV-A light dehydration of sucrose aqueous solutions depicting moisture content over time, in accordance with the present disclosure;

FIG. 8 is an illustration of results of an embodiment of a method of UV-A light dehydration of allulose aqueous solutions depicting moisture content over time, in accordance with the present disclosure;

FIG. 9A is an illustration of results of an embodiment of a method of UV-A light dehydration of sucrose aqueous solutions depicting moisture removal over time, in accordance with the present disclosure;

FIG. 9B is an illustration of results of a method of UV-A light dehydration of sucrose aqueous solutions depicting moisture removal over a smaller range of time, in accordance with the present disclosure;

FIG. 10A is an illustration of results of an embodiment of a method of UV-A light dehydration of allulose aqueous solutions depicting moisture removal over time, in accordance with the present disclosure;

FIG. 10B is an illustration of results of a method of UV-A light dehydration of allulose aqueous solutions depicting moisture removal over a smaller range of time, in accordance with the present disclosure;

FIG. 11 is a graphical representation of results of an embodiment of a method of UV-A light dehydration of food depicting starch gelatinization temperatures, in accordance with the present disclosure;

FIG. 12 is a graphical representation of results of an embodiment of a method of UV-A light dehydration of food depicting enthalpies of starch gelatinization in accordance with the present disclosure;

FIG. 13 is a graphical representation of results of an embodiment of a method of UV-A light dehydration of food depicting heat flow and starch gelatinization temperatures in accordance with the present disclosure;

FIG. 14 is a schematic diagram of an embodiment of an apparatus for UV-A light dehydration of food in accordance with the present disclosure;

FIG. 15 is a schematic diagram of an embodiment of an apparatus for UV-A light dehydration of food including an air flow moisture module and a mass module, in accordance with the present disclosure;

FIG. 16 is a flow chart of an embodiment of a method of UV-A light dehydration of food in accordance with the present disclosure;

FIG. 17 is a flow chart of another embodiment of a method of UV-A light dehydration of food in accordance with the present disclosure;

FIG. 18 is a graphical representation of results of an embodiment of a method of UV-A light dehydration of food depicting reduction of Escherichia coli population over time;

FIG. 19 is a graphical representation of results of an embodiment of a method of UV-A light dehydration of food depicting reduction of Listeria innocua population over time;

FIG. 20 is a graphical representation of results of an embodiment of a method of UV-A light dehydration of food depicting levels of Vitamin C in food;

FIG. 21 is a graphical representation of results of an embodiment of a method of UV-A light dehydration of food depicting levels of retinol in food;

FIG. 22 is a graphical representation of results of an embodiment of a method of UV-A light dehydration of food depicting levels of Beta Carotene in food;

FIG. 23 is a graphical representation of results of an embodiment of a method of UV-A light dehydration of food depicting levels of Vitamin A in food; and

FIG. 24 is a graphical representation of results of an embodiment of a method of UV-A light dehydration of food depicting levels of Vitamin C in apple.

### DETAILED DESCRIPTION

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “controller,” “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (“ISA”) instructions, machine instructions, machine dependent instructions, microcode, firmware instructions, state-setting data, or cither source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that some or all of blocks of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Embodiments of the present disclosure include an apparatus having a light source configured to expose one or more pieces of food in a chamber to ultraviolet (“UV”)-A light to dehydrate the one or more pieces of food. The apparatus also has an air flow source configured to provide air flow in the chamber across the one or more pieces of food while being exposed to the UV-A light, wherein air of the air flow has a relative humidity of less than 50 percent. The apparatus also has a controller configured to remove the one or more pieces of food from being exposed to the UV-A light and air flow in response to moisture in the one or more pieces of food being below a moisture threshold.

In some embodiments, the UV-A light has a wavelength in a range of 315 to 400 nanometers. In some embodiments, the UV-A light has a wavelength in a range of 360 to 370 nanometers. In some embodiments, the air flow has a relative humidity that is not less than 11 percent and not greater than 35 percent. In some embodiments, the chamber includes a chamber. The apparatus also includes a second chamber within the first chamber. The one or more pieces of food are positioned within the second chamber, and the second chamber is transparent at least to UV-A light. In some embodiments, a distance between a surface on which the one or more pieces of food are positioned and the light source is between 10 and 20 centimeters.

In some embodiments, the controller is further configured to turn on the light source to expose one or more pieces of food to UV-A light from the light source and to initiate air flow by the air flow source at a beginning of a dehydration cycle. The controller removing the one or more pieces of food from being exposed to the UV-A light and air flow includes the controller turning off the light source and the air flow source in response to moisture in the one or more pieces of food being below the moisture threshold.

In some embodiments, the controller removing the one or more pieces of food from being exposed to the UV-A light and air flow in response to moisture in the one or more pieces of food being below the moisture threshold includes: the controller determining that moisture of a humidity sensor sensing air flow from the one or more pieces of food is below the moisture threshold; and/or the controller determining, using a mass sensor, that a mass of the one or more pieces of food indicates that moisture of the one or more pieces of food is below the moisture threshold.

In some embodiments, the air flow source includes an air conditioner configured to reduce humidity of air flowing in an air flow inlet providing air to the one or more pieces of food to below a relative humidity threshold. In some embodiments, the air flow source provides the air flow at a rate between 18 and 22 liters per minute. In some embodiments, the air flow source includes a vacuum, a pump, and/or a fan. In some embodiments, the air flow source is connected to an air flow inlet providing the air flow to the one or more pieces of food and/or an air flow outlet removing the air flow from the one or more pieces of food.

Embodiments of the present disclosure include a method including exposing, using a light source, one or more pieces of food in a chamber to ultraviolet (“UV”)-A light to dehydrate the one or more pieces of food. The method also includes providing, with an air flow source, air flow across the one or more pieces of food in the chamber while being exposed to the UV-A light, wherein air of the air flow has a relative humidity of less than 50 percent. The method includes removing the one or more pieces of food from being exposed to the UV-A light and air flow in response to moisture in the one or more pieces of food being below a moisture threshold.

In some embodiments, the UV-A light has a wavelength in a range of 360 to 370 nanometers. In some embodiments, the method further includes: with a controller, turning on the light source to expose one or more pieces of food to UV-A light from the light source and initiating air flow by the air flow source at a beginning of a dehydration cycle. In some embodiments, removing the one or more pieces of food from being exposed to the UV-A light and air flow includes, with a controller, turning off the light source and the air flow source in response to moisture in the one or more pieces of food being below the moisture threshold.

In some embodiments, removing, with the controller, the one or more pieces of food from being exposed to the UV-A light and air flow in response to moisture in the one or more pieces of food being below the moisture threshold includes: determining, with the controller, that moisture of a humidity sensor sensing air flow from the one or more pieces of food is below the moisture threshold; and/or determining, with the controller receiving input from a mass sensor, that a mass of the one or more pieces of food indicates that moisture of the one or more pieces of food is below the moisture threshold.

In some embodiments, the method further includes reducing humidity of air flowing in an air flow inlet providing air to the one or more pieces of food to below a humidity threshold.

In some embodiments, providing the air flow includes providing the air flow at a rate of 10 to 100 liters per minute. In some embodiments, the air flow source includes a vacuum, a pump, and/or a fan.

Embodiments of the present disclosure include a system having a chamber having a light source including one or more ultraviolet (“UV”) A lights, the chamber comprising an air flow inlet and an air flow outlet. The system also has an air flow source connected to the air flow inlet and/or the air flow outlet. The air flow source includes an air mover positioned to provide air flow to the at least one of the air flow inlet or the air flow outlet, wherein air provided by the air flow source has a relative humidity of less than 50 percent. The system also includes a controller configured to: turn on the light source to expose one or more pieces of food to UV A light from the light source; turn on the air mover to provide air flow across the one or more pieces of food, wherein air exits the chamber via the air flow outlet; and turn off the light source and the air mover in response to moisture in the one or more pieces of food being below a moisture threshold.

Food dehydration is time-consuming and energy-intensive due in part to the change in phase that it necessitates. Additionally, removing moisture from food products affects the pH levels, which can result in certain pH-sensitive reactions. For example, enzymatic and nonenzymatic browning, or a “Maillard reaction”, can occur. Dehydration can also lead to uneven heating or overheating, which causes cracks in the food product. Many current dehydration techniques accelerate such reactions because they subject the food to high temperatures and momentum transfer. As such, certain products, particularly fruits and vegetables, require pre-treatment to prevent browning before applying current dehydration techniques. These pre-treatments are often chemical means, such as organic acid, sulfites, etc. Other effects of subjecting food products to high temperatures include losses in nutritional quality, such as destruction of micronutrients and denaturation of proteins. The latter can cause the proteins to become unavailable for absorption during digestion. Current methods can also result in pyrolysis and gelatinization of starch. Furthermore, high-temperature techniques such as hot-air drying have adverse environmental impacts due to their emission of greenhouse gases and waste of 35-45 percent of their energy inputs in exhaust air.

UV-C light (UV light with wavelengths of not less than 200 and not greater than 280 nm) can help reduce spoilage and pathogenic microorganisms and disinfect food packaging materials and processing surfaces. However, exposure to UV-C radiation can cause serious health problems in humans, such as cataracts, severe burns, and skin cancer.

UV-A light (UV light with wavelengths not less than 315 and not greater than 400 nm) carries a lower risk from exposure than UV-C light does. Embodiments of the present disclosure include methods that involve exposing food to UV-A light to remove moisture. As used herein, the term “food” refers to any edible article, including, but not limited to, fruits, vegetables, carbohydrates, starchy foods, sugars (e.g., sucrose, allulose), solutions including sugars, and/or any combination thereof.

Due to UV-A light's capability for deep penetration, it also requires even less energy for use in dehydration and carries the benefits of low maintenance and installation costs. In comparison to other dehydration methods, UV-A dehydration methods described herein carry low installation costs, lower energy consumption, and lower maintenance costs. Additionally, the nutritional and aesthetic drawbacks associated with high-temperature dehydration methods are not a concern with UV-A light dehydration. Food dehydrated through UV-A light may show less browning and retain more nutritional integrity compared to food dehydrated through other methods.

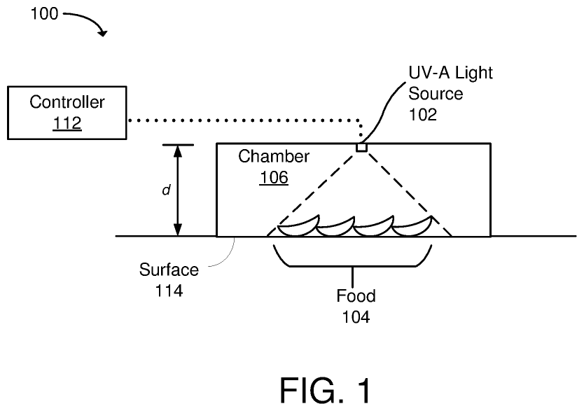

FIG. 1 is a schematic diagram that depicts a system 100 for UV-A light dehydration of food 104, according to an embodiment of the present disclosure. As illustrated in FIG. 1, the food 104 is exposed to a UV-A light source 102. The UV-A light source 102 and the food 104 are both within a chamber 106. The system 100 also includes a controller 112 in communication with the UV-A light source 102. The controller 112 is configured to, for example, actuate turning on the UV-A light source to expose the food 104 to the UV-A light. The controller 112 is also configured to actuate removing the food 104 from exposure to the UV-A light. As used herein, “removing” food 104 from exposure to UV-A light is not limited to actions involving physical movement of the food 104. In some embodiments, the controller 112 removes the food 104 from exposure by turning off the UV-A light source 102 and/or decreasing the intensity of emitted UV-A light. In some embodiments, the controller 112 opens a door to the chamber 106 and indicates that the food 104 is ready to be removed from the chamber 106.

The UV-A light sources 102 emit light with wavelengths in the UV-A range (no less than 315 nm and no greater than 400 nm). In some embodiments, the wavelengths are no less than 360 nm and no greater than 370 nm. For example, the wavelengths are approximately 365 nm. The higher wavelengths of UV-A light cause the light to penetrate the food 104 at a deeper level, which may break up the cells of the food 104 more easily and dehydrate it more efficiently. In some embodiments, the light that the food samples 104 are exposed to are of wavelengths such that they are not likely to be absorbed by the nutrients in the food samples 104. Use of these wavelengths may help to improve the nutritional integrity of dehydrated food compared to food that is dehydrated through other methods.

The food 104 may be of any type of food that could benefit from dehydration. For example, food 104 may include, but is not limited to, starchy foods, fruits, vegetables, and any combination thereof. More specific examples include, but are not limited to, apples, mangoes, purple potatoes, sweet potatoes, or any combination thereof.

The food 104 is prepared prior to being exposed to the UV-A light. In some embodiments, preparing the food 104 involves removing peels. In some embodiments, the food 104 is also cut before exposing it to the UV-A light. For example, the food 104 is cut into whatever shape is desired for the final, dried product. For example, if the food 104 includes a potato, the potato could be cut into wedges, French fry shapes, or chip shapes. The food 104 can also be cut into shapes that maximize surface area of exposure to the UV-A light. For example, thin slices of the food 104 are used.

The food 104 is placed within the chamber 106. This can be done, for example, through a lid and/or door to the chamber 106 that lifts up to allow the food 104 to be placed therein. In some embodiments, the food 104 is placed upright within the chamber to allow for maximum exposure to the UV-A light. The chamber 106 may include, for example, a rack that allows the food 104 to be held in such a position. The rack includes slots so that each piece of food 104 does not overlap or touch other pieces of food 104.

Next, the food 104 is exposed to UV-A light. This is done, for example, by turning on a UV-A light source 102. For example, one or more UV-A light sources 102 are positioned within the chamber 106 above the food samples 104. Although FIG. 1 illustrates one UV-A light source 102 positioned at the top of the chamber 106, embodiments of the present disclosure are not so limited. For example, embodiments include multiple light sources 102. In some embodiments, the light sources 102 are positioned on walls of the chamber 106 as well as the top side of the chamber 106.

In some embodiments, the UV-A light from the UV-A light source 102 is of a high intensity. For example, the UV-A light is of an intensity of approximately 6 milliwatts per square centimeter (“mW/cm²”). In other examples, the UV-A light is of an intensity of not less than 4 mW/cm² and not greater than 7 mW/cm². Although not illustrated in FIG. 1, in some embodiments, intensity of the light is measured and confirmed with a sensor within the chamber 106, such as a radiometer. In some embodiments, the intensity of the UV-A light from the UV-A light source 102 is determined and set based on other factors, such as a desired dehydration time. Higher intensities of UV-A light will shorten dehydration time but consume more energy. Likewise, lower intensities will take more time but could require less energy.

In some examples, the food 104 is dehydrated for a few hours. For example, the food 104 is exposed to UV-A light for approximately eight hours to remove approximately 95% of the initial moisture. This time period can be lengthened to increase moisture removal. Increased time periods of exposure can also result in more elimination of pathogenic and spoilage microorganisms.

For example, exposing the food 104 to the UV-A light for approximately ten hours may accomplish more moisture removal and anti-microbial benefits.

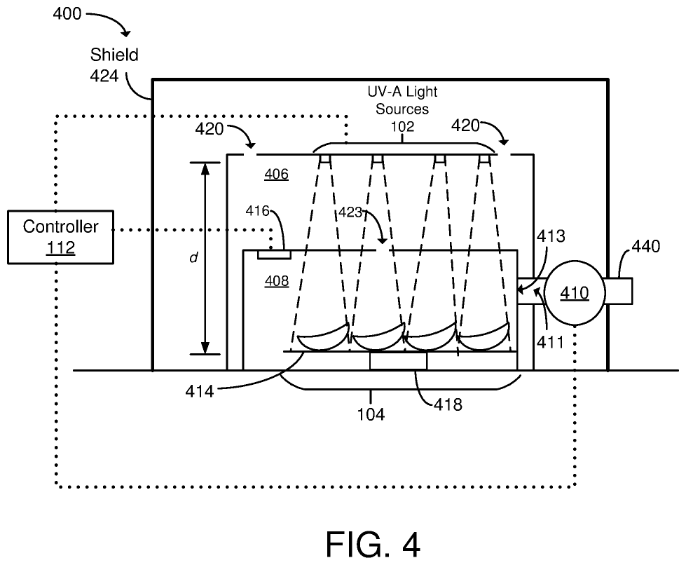

In some embodiments, the controller 112 removes the food 104 from UV-A light exposure after a predetermined period of time. This is done, for example, by the controller turning off the UV-A light source 102, notifying a user that the dehydration process is complete, and/or opening a door of the chamber 106. In other embodiments, the controller 112 determines that the process is complete by weighing and/or measuring the moisture of the food 104, as illustrated in and discussed in connection with FIG. 4.

Although FIG. 1 shows the controller 112 outside of and separate from the chamber 106, embodiments of the present disclosure are not so limited. In some embodiments, the controller 112 is within the chamber 106. In some embodiments, the controller 112 is combined with the chamber 106 into an apparatus for food dehydration.

The distance d between the UV-A light source 102 and the surface 114 of the chamber 106 on which the food 104 is resting is considered when determining how long to expose the food 104 to the UV-A light source 102 and/or at what intensity the UV-A light source 102 should emit light. In addition, the distance d is considered with regard to a light pattern from a UV-A light source 102 in terms of spread of light on the food 104 at various distances from the UV-A light source 102. In some embodiments, the distance d is approximately 15 centimeters (“cm”). For example, the distance d between the surface 114 and the UV-A light sources 102 is not less than 10 cm and not greater than 20 cm.

In some embodiments, the system 100 is within an indoor environment. The indoor environment is at room temperature, or approximately 20-25° C. In some embodiments, the ambient air in the environment of the system 100 has a relative humidity of not greater than 30 percent.

In some embodiments, the air in the indoor environment is maintained such that it approximately or slightly warmer than room temperature. For example, the air of the indoor environment is not less than 20 and not greater than 25° C. The indoor environment is equipped with one or more temperature sensors. The indoor environment is also equipped with heating and cooling systems such that, if the temperature falls outside of the preferred range, a heating element, cooling clement, or notification element is actuated to automatically heat the environment, cool the environment, and/or notify an appropriate person of the temperature issue. The heating and cooling systems (HVAC) of the environment can also reduce the relative humidity of air in the environment. In some embodiments, the HVAC system maintains the air in the environment to have a relative humidity of not less than 11 percent and not greater than 35 percent. For example, the air in the environment has a relative humidity of approximately 22.8 percent.

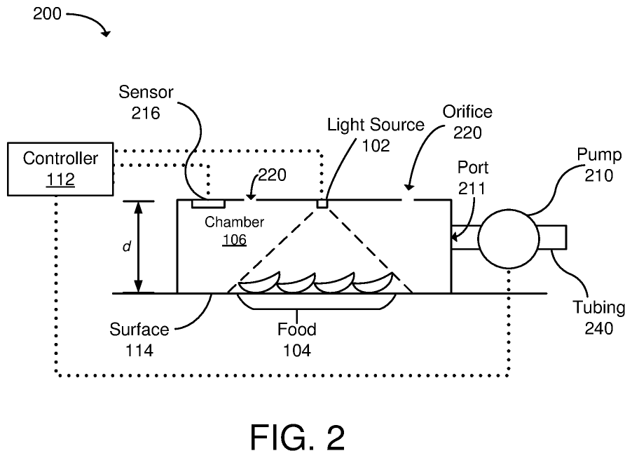

FIG. 2 is a schematic diagram illustrating an embodiment of a system 200 of UV-A light dehydration of food 104 with a pump 210 (which may also be called an air mover 210), in accordance with the present disclosure. In some climates and environments, the relative humidity of air within the chamber (e.g., chamber 106) is in the appropriate range for the dehydration. In other words, the air within the chamber 106 has an acceptably low relative humidity. However, to ensure maintenance of optimal relative humidity, systems of UV-A light dehydration, such as system 200, include additional components. For example, the system 200 includes an air mover 210 and a humidity sensor 216 within the chamber 106 for sensing humidity of air within the chamber 106. In some embodiments, the controller 112 is electrically and/or communicably coupled to the humidity sensor 216, air mover 210, and/or UV-A light source 102.

In some embodiments, the chamber 106 is connected to the air mover 210 in order to expose the food 104 to an air flow. For example, the chamber 106 is connected to the air mover 210 through a port 211 of the chamber 106. The air mover 210 includes, for example, a pump, a vacuum, a fan, an air compressor, or any combination thereof. Although not shown in FIG. 2, in some embodiments, the air mover 210 is connected to another air source external to the chamber 106. In some embodiments, ambient air from the environment flows into the chamber 106 through orifices 220, and the air mover 210 pulls air out of the chamber 106 to facilitate dehydration. For example, the air mover 210 is a pump that pumps air out of the chamber 106. In other embodiments, the air mover 210 blows air into and/or moves air out of the chamber 106 through the port 211. In some embodiments, the air mover 210 removes air from the chamber 106 at a rate in the range of 10 liters per minute (“L/min”) to 100 L/min. In some embodiments, the air mover 210 removes air from the chamber 106 at a rate of not less than 18 L/min and not greater than 22 L/min. For example, the air mover 210 removes air from the chamber 106 at rate of approximately 20 L/min.

In some embodiments, the air mover 210 is connected to the port 211 through tubing 240. In some embodiments, the air mover 210 includes an air dryer configured to reduce humidity of air flowing into the chamber 106 via the port 211 and provide air to the food 104 that is below a certain humidity threshold. In some embodiments, the system 200 includes an air flow source that includes both an air dryer and an additional air mover 210.

In some embodiments, air flowing in through the orifices 220 has a low relative humidity. For example, the air flow has a relative humidity of no greater than 35 percent. In some embodiments, the air flow is not less than 11 percent. In some embodiments, although not shown in FIG. 2, the relative humidity of air entering the chamber 106 through the orifices 220 is controlled by a heating, ventilation, and air conditioning (“HVAC”) system of the indoor environment. For example, the HVAC system reduces the relative humidity of the ambient air in the indoor environment through cooling and/or heating. In some embodiments, the controller 112 communicates with the HVAC system to adjust the relative humidity of the ambient air and, consequently, the relative humidity of air entering the chamber 106 through the orifice 220.

Although not shown in FIG. 2, the relative humidity of the ambient air of the environment of the system 200 is monitored using a humidity sensor exterior to the chamber 106. In some embodiments, this sensor is similar to the humidity sensor 216 that is within the chamber 106. If the relative humidity is not within the desired range, an HVAC system of the environment can be used to adjust the humidity. In some embodiments, the humidity sensor is in communication with the controller 112, and the controller 112 is in communication with the HVAC system. As such, the controller 112 determines, based on data received from the humidity sensor, that the humidity of the environment needs to be adjusted and sends a message to the HVAC system to adjust the humidity or actuates the HVAC system adjusting the humidity. In other embodiments, the HVAC system includes a humidity sensor and/or is in communication with a humidity sensor. The HVAC system is configured to determine when a humidity of the environment is outside of an ideal range and adjust the humidity of the environment accordingly. Alternatively, the HVAC system includes inputs through which a user can adjust the humidity.

Although embodiments of the present disclosure include monitoring relative humidity and making adjustments to change the relative humidity of an ambient air in an environment and/or of air within the chamber 106, embodiments of the present disclosure also include measuring and/or monitoring the humidity of ambient air and/or air within a chamber 106 and making adjustments to the humidity without determining the relative humidity.

In some embodiments, relative humidity of ambient air within the indoor environment is altered by receiving air from outside of the indoor environment. For example, during certain seasons and in certain climates, ambient air outside of the indoor environment may have a low relative humidity. Air can be brought from outside into the indoor environment to decrease the relative humidity of ambient air in the indoor environment.

In some embodiments, the humidity sensor 216, in addition or alternative to including a humidity sensor, includes a barometer to measure air pressure within the chamber 106. In some embodiments, methods UV-A dehydration of foods include verifying, before and/or throughout the process, that the air pressure in the chamber 106 is close to atmospheric air pressure, or approximately 14.7 pounds per square inch (“PSI”). The barometer, in some embodiments, is in communication with the controller 112. As such, the controller 112 determines that the air pressure in the chamber 208 is more than an acceptable deviation away from atmospheric air pressure. In response, the controller 112 performs an action including, but not limited to, at least one of the following actions: notifying a user, displaying the air pressure on a display of the chamber 208, actuating an air mover 210 to adjust air pressure, and/or any combination thereof. The air pressure of the chamber 106 can also be measured prior to placing the food 104 within the chamber 106.

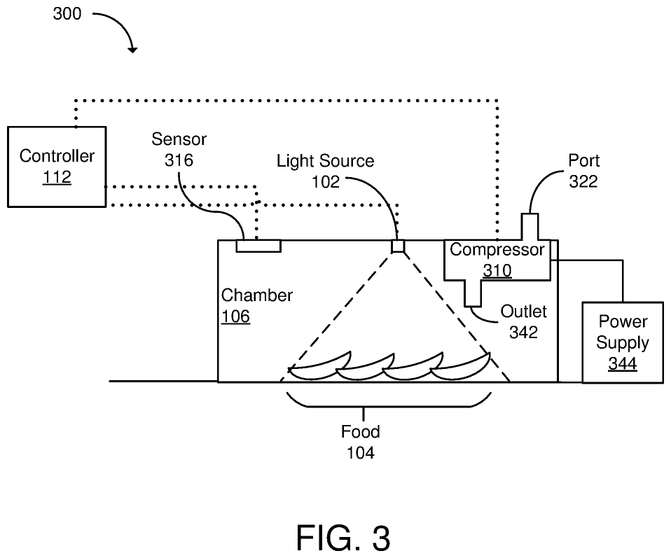

FIG. 3 is a schematic diagram illustrating an embodiment of a system 300 of UV-A light dehydration of food 104 with an air compressor 310, in accordance with the present disclosure. The system 300 includes a chamber 106 with a light source 102 exposing food 104 to UV-A light. The chamber 106 also includes a sensor 316 and an air mover, such as an air compressor 310. The air compressor 310 is connected to a port 322 of the chamber 106.

In some embodiments, the air compressor 310 draws ambient air from outside of chamber 106 through the port. The air compressor 310 then forces the air under pressure within the air compressor 310 and forces the air through the output 342 of the air compressor 310. Thus, the air compressor 310 can increase the air pressure within the chamber 106. In some embodiments, the air compressor 310 is connected to a power supply 344 that can be either internal or external to the chamber 106.

Ideally, the air pressure within the chamber 106 is at atmospheric pressure. In some embodiments, the air pressure of the chamber 106 is checked prior to the dehydration process. This is done, for example, via a sensor 316 within the chamber. If necessary, the air pressure is adjusted via the air compressor 310 so that it is within an acceptable deviation of atmospheric air pressure. In some embodiments, the controller 112 is electrically and/or communicatively coupled to the air compressor 310 and/or to the sensor 316. In response to determining, via the sensor 316, that a change in air pressure within the chamber 106 is needed, the controller 112 actuates the air compressor 310 to turn off and/or on.

FIG. 4 is a schematic diagram illustrating an embodiment of a system 400 of UV-A light dehydration of food 104 with an air mover 410, an interior chamber 408 (second chamber) and an outer first chamber 406, in accordance with the present disclosure. As illustrated in FIG. 4, in some embodiments, the first chamber 406 includes another interior chamber 408 within the first chamber 406. The food 104 is placed within the interior chamber 408. For example, in some embodiments, the interior chamber 408 is removable from the first chamber 406. In some embodiments, the food 104 is placed within the interior chamber 408 before the interior chamber 408 is placed within the first chamber 406. This allows the food 104 to be positioned within the interior chamber 408 for more surface area exposure to the UV-A light outside of the first chamber 406. For example, some embodiments include placing a first batch of food 104 into an interior chamber 408 while the interior chamber 408 is outside of the first chamber 406. The interior chamber 408 is then placed into the first chamber 406, and the food 104 is exposed to the UV-A light via the light source 102 of the first chamber 406. While the food 104 is being exposed to the UV-A light, a second batch of food is prepared. For example, although not shown in FIG. 4, embodiments of the present disclosure include an additional interior chamber 408 configured to be placed within and removed from the first chamber 406. The second batch of food is positioned within additional interior chamber while the first batch is being exposed to the UV-A light. After the first batch of food 104 is removed from exposure to the UV-A light sources 102, the interior chamber 408 containing the first batch is removed from the first chamber 406, and the additional chamber is placed within the first chamber 406 without disrupting the positioning of the second batch. Preparing the next batch of food while the first batch is under the UV-A light sources 102 improves efficiency and allows higher yields of food to be dehydrated using a set of light sources 102 in less time.

In other embodiments, the interior chamber 408 includes, for example, a lid and/or a door to allow the food 104 to be placed therein. In some embodiments, the interior chamber 408 is made of glass or other translucent and/or transparent material such that the UV-A light from the UV-A light source 102 of the first chamber 406 can penetrate the interior chamber 408. In some embodiments, the interior chamber 408 is closed but is not hermetically sealed. The interior chamber 408 is not completely airtight, but it is mostly closed. The interior chamber 408 has a number of orifices 423 to allow air to flow in and/or out of the interior chamber 408. In some embodiments, the first chamber 406 has a door on at least one side that opens to receive the interior chamber 408 and/or to receive the food samples 104.

The controller 112 is configured to determine a moisture content of the food 104 prior to exposing the food 104 to the UV-A light through UV-A light sources 102. This determining of an initial moisture content provides a starting point for determining at what moisture level the food 104 should be removed from the UV-A light. For example, the food 104 includes an apple slice. The apple slice has an initial moisture content of 85%, or 5.67 kilograms of water per kilogram dry solids (“kg H₂O/kg d.s.”). If the goal of the process is to remove 95% of that moisture, the method can end when the moisture content is equal to approximately 5% of 6.1 kg H₂O/kg d.s., or approximately 0.5 kg H₂O/kg d.s. In some examples, the controller 112 determines the moisture content of the food through:

user inputs, assumptions based on a given or estimated value for the type of food, weighing, vacuum oven methods, or any combination thereof.

In some examples, changes in the mass of the food 104 indicate changes in moisture content. As the food 104 is dehydrated, it loses mass. In some examples, these changes in mass are measured through a scale 418. The scale 418, for example, is underneath the surface 414 onto which the food 104 is placed. The scale 418 is electrically and/or communicatively coupled to the controller 112. In some examples, the food 104 is weighed before exposing the food 104 to the UV-A light, and the food 104 continues to be weighed throughout the process. When the food 104 has lost enough mass to reflect the desired loss in moisture, the 104 can be removed from UV-A light exposure. For example, the controller 112 is in communication with the scale 418, and the controller 112 automatically actuates turning off or turning down the UV-A light sources 102 when the scale 418 indicates that the food 104 has reached a predetermined mass.

Some examples involve checking the mass of the food 104 periodically. For example, rather than continuously monitoring the mass, the scale 418 communicates the mass measurements to the controller 112 on an hourly basis. In another example, the scale 418 includes a display, and personnel check the display at certain intervals to determine when to remove the food 104 from exposure.

Although FIG. 4 illustrates the controller 112 in communication with the scale 418, examples of the present disclosure are not so limited. For example, the system 400 does not include a controller 112. The scale 418 includes a display that shows the mass of the food 104. A user can then view the mass on the display and determine when to remove the food 104 from exposure to the UV-A light sources 102 based in part on the mass. For example, if the user sees that the food 104 has lost an amount of mass indicating adequate moisture removal, the user may remove the food 104 from exposure by turning off the light sources 102 and/or removing the food 104 from the chambers 106 and 408.

In some examples, a shield 424 is placed over the first chamber 406 and/or over the interior chamber 408 to protect any persons involved in the dehydration, since small amounts of UV-A light may escape from either chamber 106 and/or 408. The shield 424 is particularly useful in examples that include orifices 420 in the first chamber 406 and/or orifices 423 in the interior chamber 408.

Air is removed from interior chamber 408 and expelled out of the port 413 of the interior chamber 408 through tubing 440 and out of the port 411 of the first chamber 406 to the exterior of the first chamber 406 via the air mover 410. In examples in which the first chamber 406 and the interior chamber 408 are within a shield 424, the air is also expelled to an exterior of the entire system 400, or an exterior of the shield 424, as illustrated in FIG. 4.

The interior chamber 408 has a number of orifices 423. For example, the interior chamber 408 has five orifices 423, although only one is shown in FIG. 4. One orifice 423 is in the geometric center of a lid of the interior chamber 408, and the remaining four orifices form a rectangle around the center orifice 423.

In some examples, the first chamber 406 has a number of orifices. For example, the first chamber 406 is rectangular and has four orifices, each near a corner. In some examples, the shield 424 is placed over the first chamber 406 to minimize human exposure to the UV-A light. The shield 424 has an open bottom such that it can be easily lifted onto and off of the chambers 106 and 408 for temporary blockage of the orifices 420.

As discussed above in connection with FIG. 1 and the first chamber 406, the interior chamber 408 can be maintained with atmospheric conditions, such as atmospheric air pressure. The interior chamber 408 includes a number of orifices 423 and/or ports 413 through which air can move. If the system 400 is within an indoor environment, the air moving through orifices 423 and/or ports 413, in some examples, is air from the indoor environment. For example, if the indoor environment is at room temperature and low relative humidity, the air moving through the orifices 423 and/or ports 413 will be at room temperature and low relative humidity.

In some examples, the first chamber 406 is a UV-A light crosslinker with a controller 112 and light sources 102 capable of delivering a controlled amount of UV-A light. In some examples, the first chamber 406 includes a display and inputs allowing a user to adjust the wavelengths, intensity, and/or duration of the UV-A light. In some examples, the wavelength of the light is adjusted. In other examples, the wavelength of the light is predetermined. Although examples of the present disclosure include exposing the food 104 to light in the UV-A wavelength range, in some examples, the first chamber 406 is also capable of emitting light outside of this range.

In some examples, the interior chamber 408 is positioned within the first chamber 406 such that the distance between the surface 414 on which the food 104 is resting and the UV-A light sources 102 is approximately 15 centimeters (“cm”). For example, the distance d between the surface 414 and the UV-A light sources 102 is not less than 10 cm and not greater than 20 cm, and the intensity of the UV-A light sources 102 is not less than 4.6 mW/cm² and not greater than 5.0 mW/cm². In some examples, the distance d is less than 10 cm, and the intensity of the light sources 102 is less than 4.8 mW/cm². In other examples, the distance d is greater than 20 cm, the intensity of the light sources 102 is raised to be greater than 4.8 mW/cm².

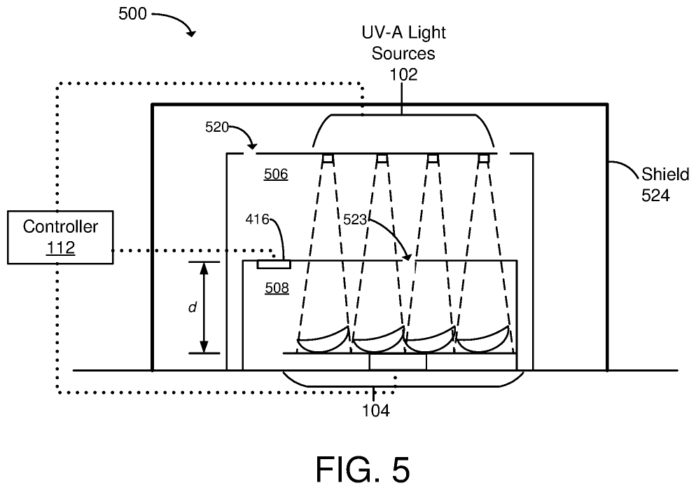

FIG. 5 is a schematic diagram illustrating an embodiment of a system 500 of UV-A light dehydration of food 104 with a shield 524, in accordance with the present disclosure. As illustrated in FIG. 5, in some examples, the system 500 does not include an air mover, such as the air mover 410 illustrated in FIG. 4. For example, in some examples, the ambient air of the environment of the system 500 is of a relative humidity in an appropriate range for the UV-A dehydration. For example, the ambient air of the environment of the system 500 already has a relative humidity of less than 50%. The system 500 shown in FIG. 5, which does not include an air mover, may be particularly effective in environments in which the relative humidity of the ambient air is not greater than 35%. In some examples, the orifices 520 and 523 of the chamber(s) 506 and 508 allow this ambient air to flow into the chamber(s) 506 and 508. In some examples, the food 104 is still exposed to air with a relative humidity of not greater than 35% as a result of the environment, even if the system 500 does not include an air mover. Although not shown in FIG. 5, in some examples, the shield 524 includes orifices and/or a porous material that allows air to flow through.

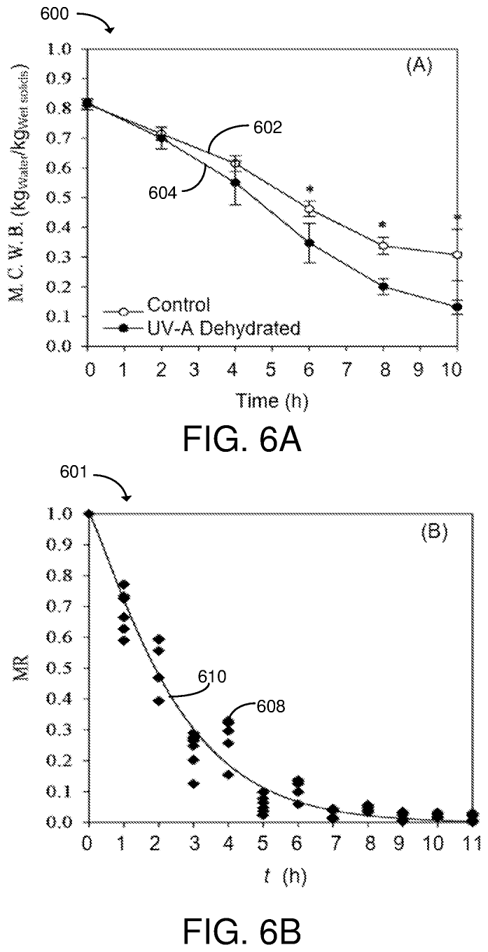

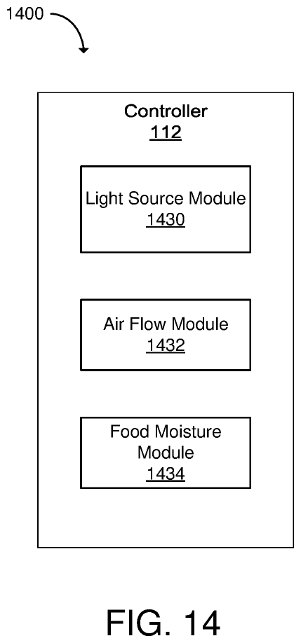

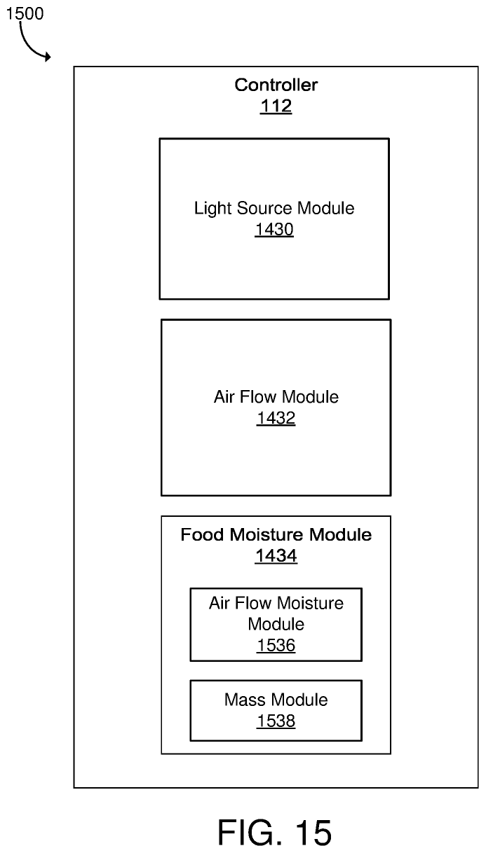

FIG. 6A is an illustration of results of an embodiment of a method of UV-A light dehydration of food depicting moisture content over time, in accordance with the present disclosure. For example, FIG. 6A is an illustration of results of methods 1600 and 1700 shown in FIGS. 16 and 17.

FIG. 6A includes a graph 600 of moisture content wet basis (“MCWB”) of food as a function of time in hours (h). Time in hours is tracked from the time at which the food is exposed to the UV-A light. The MCWB may also be referred to herein as the “moisture content” of the food. For example, as shown in FIG. 6A, the initial MCWB of a food sample may be approximately 0.82 kg_{Water}/kg_{Wet sample}. Line 602 of FIG. 6A shows the MCWB over time of food samples dried using conventional methods (e.g., methods not utilizing UV-A light). Line 604 of FIG. 6A shows the MCWB over time of food samples dried using the methods described herein, such as methods 1600 and 1700 of FIGS. 16 and 17. As illustrated in FIG. 6A, the MCWB of food samples dried using UV-A dehydration 604 is lower than the MCWB of food samples dried using conventional methods, particularly beginning at the 4(h) mark.

As shown in FIG. 6A, after approximately ten hours, food samples dehydrated according to the techniques described herein can achieve a moisture removal of over 95%. As such, examples of the present disclosure include exposing food to UV-A light for a period of, for example, approximately ten hours.

FIG. 6B is an illustration of results of an embodiment of a method of UV-A light dehydration of food depicting moisture removal over time, in accordance with the present disclosure. For example, FIG. 6B depicts moisture removal over time resulting from methods 1600 and 1700 shown in FIGS. 16 and 17.

FIG. 6B illustrates a graph 601 of the moisture ratio (“MR”) over time (t(h)) for food 104 dehydrated according to examples of the present disclosure. The moisture ratio of the food is a function of the moisture contents dry basis of the food at an initial time, equilibrium time, and time (t). The equilibrium time is a time at which the moisture content remains relatively stable for a relatively long period of time. The plot points 608 represent actual data of dehydrated food, and line 610 is a fit line. Specifically, the fit line 610 is a Weibull distribution. Based on the fit line 610, the time (t) in hours to achieve a particular level of moisture removal (MR) can be approximated as follows:

$$t = - α \sqrt[β]{{log}_{e} ( M R )} . \qquad ( 1 )$$

α is a scalar parameter representing the time necessary to accomplish approximately 63% of the moisture removal process (h) for the given MR. β is a dimensionless shape factor that is proportional to a rate of dehydration. The MR can be expressed as:

$$M R = \frac{{M}_{t} - {M}_{0}}{{M}_{e} - {M}_{0}} , \qquad ( 2 )$$

where Mₜ represents the moisture content dry basis at a given time (t), M₀ represents the initial moisture content dry basis, and Mₑ represents the moisture content at an equilibrium, or a moisture content that level that doesn't change or changes only minimally over time. Mₜ, M₀, and Mₑ each have units of kg_{water}/kg_{solids}.

In some examples, α and/or β are determined based on at least one of: estimated values, past results for dehydration conducted in a similar environment and/or under similar conditions, the intensity of the light source(s), the type of food being dehydrated, the specific wavelengths being used, the relative humidity of air flow, the rate of air flow into the chamber housing the food, or any combination thereof. For some types of food and certain climates, α is approximately 2 to 3 hours, for example. For some types of food and certain climates, β is no less than 1 but not greater than 1.5, for example. In some examples, a controller stores data from past dehydration processes to determine α and/or β.

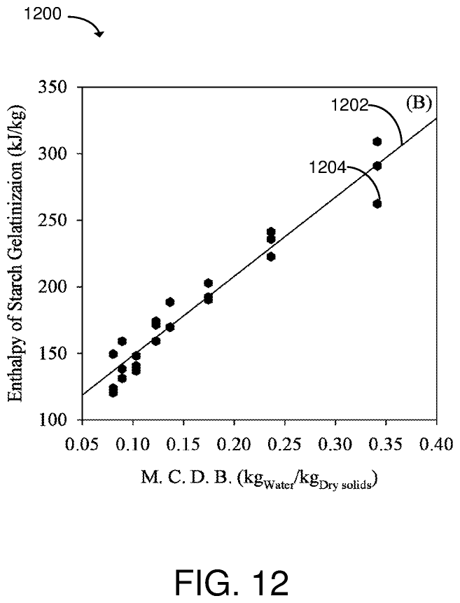

Examples of the present disclosure include determining a desired moisture removal. For example, this value is received by a controller (e.g., controller 112) from a user. Examples also include predicting a dehydration time based on the desired moisture removal and estimated α and β values. For example, dehydration time is predicted using Equation 2. The controller 112 is configured to remove the food from UV-A light exposure. For example, the controller 112 performs at least one of the following actions when the food has been exposed to UV-A light for at least the calculated time t: turn off or turn down intensity of the UV-A light sources, notify a user of the expiration of the time period, open a door and/or lid of a chamber housing the food, or any combination thereof. In some examples, the controller 112 is configured to determine a moisture removal of the food before removing the food from the UV-A light exposure. For example, when a time t has elapsed since the beginning of the UV-A light exposure, the controller determines a moisture content of the food based on, for example, the moisture of content of air flow coming from the food and/or the mass of the food compared to the food's initial mass. This is done, for example, through a food moisture module 1434 of a controller 112, as shown in FIG. 14.

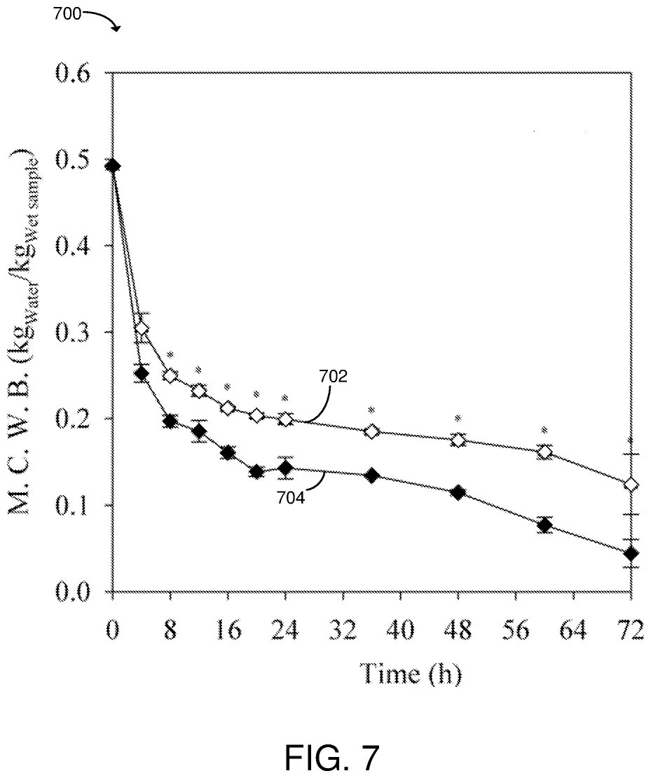

FIG. 7 is an illustration of results of an embodiment of a method of UV-A light dehydration of sucrose aqueous solutions depicting moisture content over time, in accordance with the present disclosure. For example, FIG. 7 is an illustration of results of methods 1600 and 1700 shown in FIGS. 16 and 17. As shown in FIG. 7, examples of the present disclosure include dehydration of solutions including sucrose. In some examples, a sucrose solution is a by-product of another dehydration cycle and/or process. For example, a sucrose solution is a by-product of dehydrating a fruit via osmotic drying. Examples of the present disclosure include dehydrating such a solution via exposure to UV-A light, as described herein. In some examples, the sucrose solution is dehydrated to be re-used as a sweetener.

FIG. 7 includes a graph 700 of MCWB, or moisture content, of a sucrose solution as a function of time in hours (h). Line 702 of FIG. 7 shows the MCWB over time of the sucrose solution dried using conventional methods (e.g., without exposing the food to UV-A light). Line 704 of FIG. 7 shows the MCWB over time of the sucrose solution dried using the methods described herein, such as methods 1600 and 1700 of FIGS. 16 and 17. As illustrated in FIG. 7, the MCWB of food samples dried using UV-A dehydration 704 is lower than the MCWB of food samples dried using conventional methods, particularly beginning at the 4(h) mark.

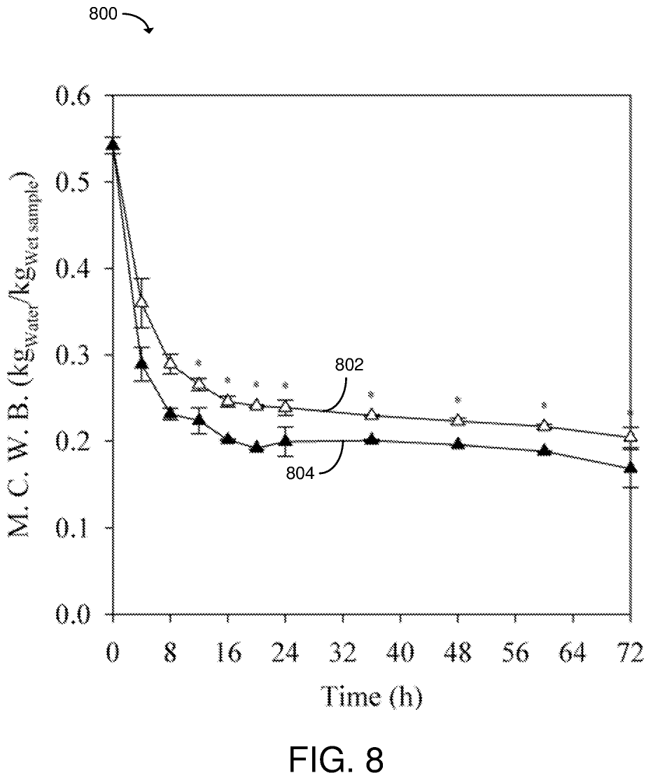

FIG. 8 is an illustration of results of an embodiment of a method of UV-A light dehydration of allulose aqueous solutions depicting moisture content over time, in accordance with the present disclosure. For example, FIG. 8 is an illustration of results of methods 1600 and 1700 shown in FIGS. 16 and 17. As shown in FIG. 8, examples of the present disclosure include dehydration of solutions including allulose. In some examples, an allulose solution is a by-product of another dehydration cycle and/or process. For example, an allulose solution is a by-product of dehydrating a fruit via osmotic drying. Examples of the present disclosure include dehydrating such a solution via exposure to UV-A light, as described herein. In some examples, the allulose solution is dehydrated to be re-used as a sweetener.

FIG. 8 includes a graph 800 of MCWB, or moisture content, of an allulose solution as a function of time in hours (h). Line 802 of FIG. 8 shows the MCWB over time of the sucrose solution dried using conventional methods (e.g., without exposing the food to UV-A light). Line 804 of FIG. 8 shows the MCWB over time of the sucrose solution dried using the methods described herein, such as methods 1600 and 1700 of FIGS. 16 and 17. As illustrated in FIG. 8, the MCWB of food samples dried using UV-A dehydration 804 is lower than the MCWB of food samples dried using conventional methods, particularly beginning at the 4(h) mark.

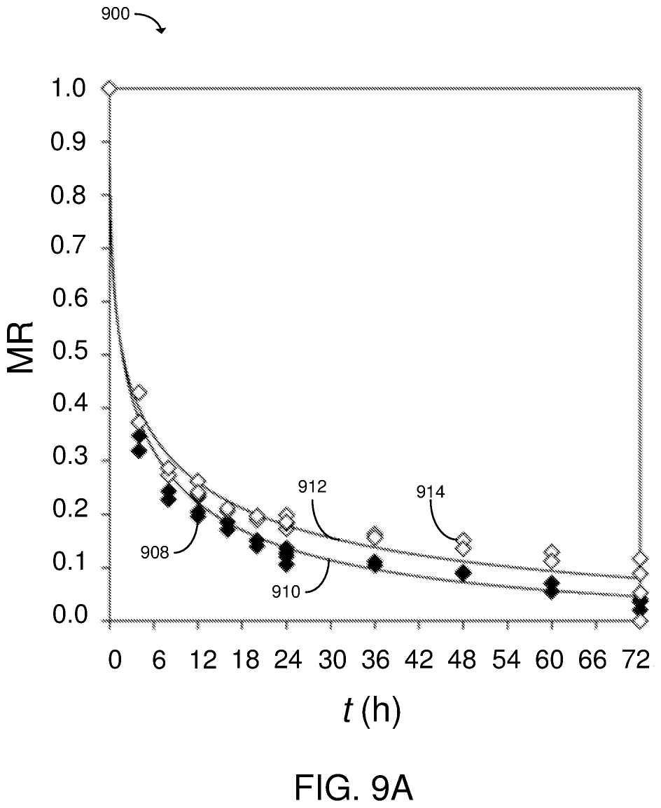

FIG. 9A is an illustration of results of an embodiment of a method of UV-A light dehydration of sucrose depicting moisture removal over time, in accordance with the present disclosure. For example, FIG. 9A is an illustration 900 of results of method 1600 and 1700 shown in FIGS. 16 and 17.

FIG. 9A illustrates the MR over time (t(h)) for a sucrose solution dehydrated according to examples of the present disclosure. The plot points 908 represent actual data of a dehydrated sucrose solution, and line 910 is a fit line. Specifically, the fit line 910 is a Weibull distribution. The plot points 914 are plot points for a sucrose solution dehydrated using conventional methods (e.g., without exposing the food to UV-A light), and line 912 is a fit line for those plot points 914.

FIG. 9B is an illustration of results of a method of UV-A light dehydration of sucrose aqueous solutions depicting moisture removal over a smaller range of time, in accordance with the present disclosure. FIG. 9B includes a graph 901 illustrating the points 908, 914 and fit lines 910, 912 of FIG. 9A, but in a range of 0-24 hours rather than 0-72 hours.

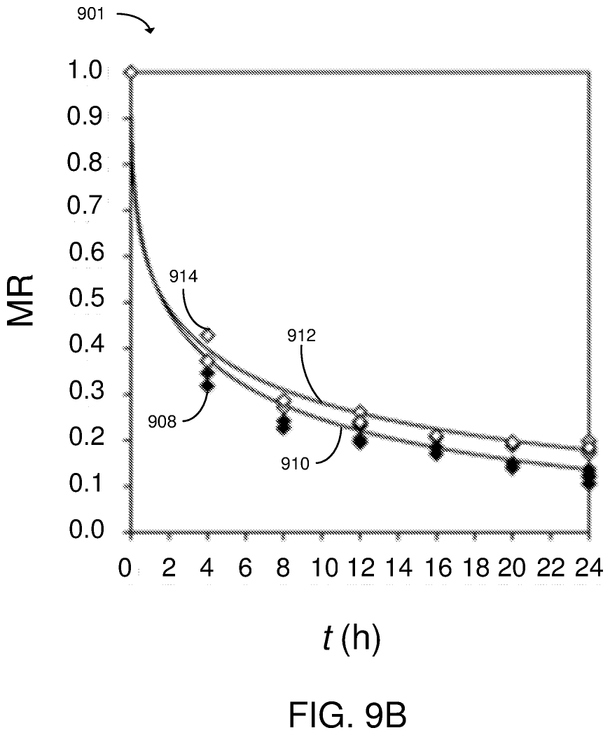

FIG. 10A is an illustration 1000 of results of an embodiment of a method of UV-A light dehydration of allulose aqueous solutions depicting moisture removal over time, in accordance with the present disclosure. For example, FIG. 10A is an illustration of results of method 1600 and 1700 shown in FIGS. 16 and 17.

FIG. 10A illustrates the MR over time (t(h)) for a sucrose solution dehydrated according to examples of the present disclosure. The plot points 1008 represent actual data of a dehydrated sucrose solution, and line 1010 is a fit line. The plot points 1014 are plot points for a sucrose solution dehydrated using conventional methods (e.g., without exposing the food to UV-A light), and line 1012 is a fit line for those plot points 1014.

FIG. 10B is an illustration 1001 of results of a method of UV-A light dehydration of allulose aqueous solutions depicting moisture removal over a smaller range of time, in accordance with the present disclosure. FIG. 10B includes a graph 1001 illustrating the points 1008, 1014 and fit lines 1010, 1012, but over a smaller range of time t of 0-24 hours, rather than 0-72 hours, as shown in FIG. 10A.

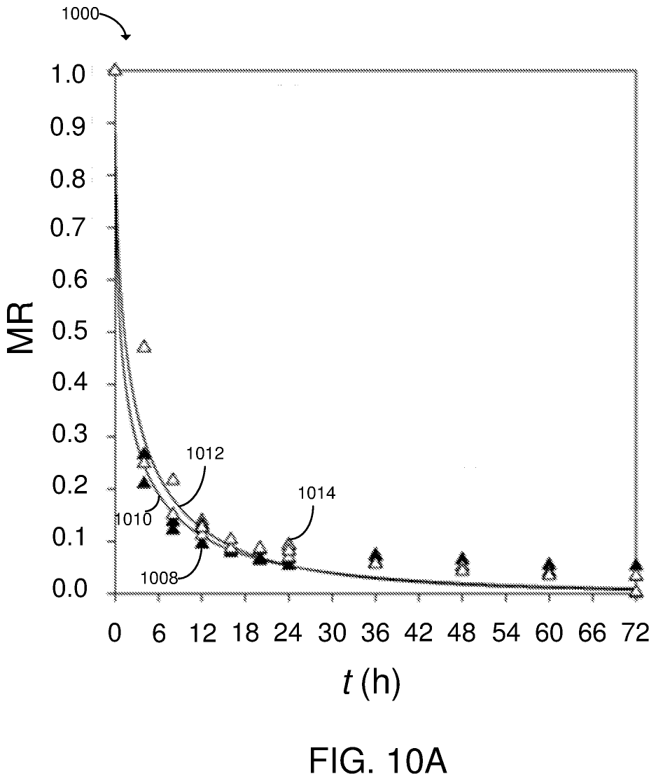

FIG. 11 is a graphical representation of results of an embodiment of a method of UV-A light dehydration of food depicting starch gelatinization temperatures, in accordance with the present disclosure. FIG. 11 includes a graph 1100 of starch gelatinization temperatures of purple potatoes with different water activity levels (a_{w}) dehydrated according to examples of the present disclosure, such as methods 1600 and 1700. The starch gelatinization temperature represents the temperature at which the starch granules of the purple potatoes dissolve into water. The water activity (dw.) represents the ratio between the vapor pressure of the purple potatoes at equilibrium and the vapor pressure of pure water at the same temperature.

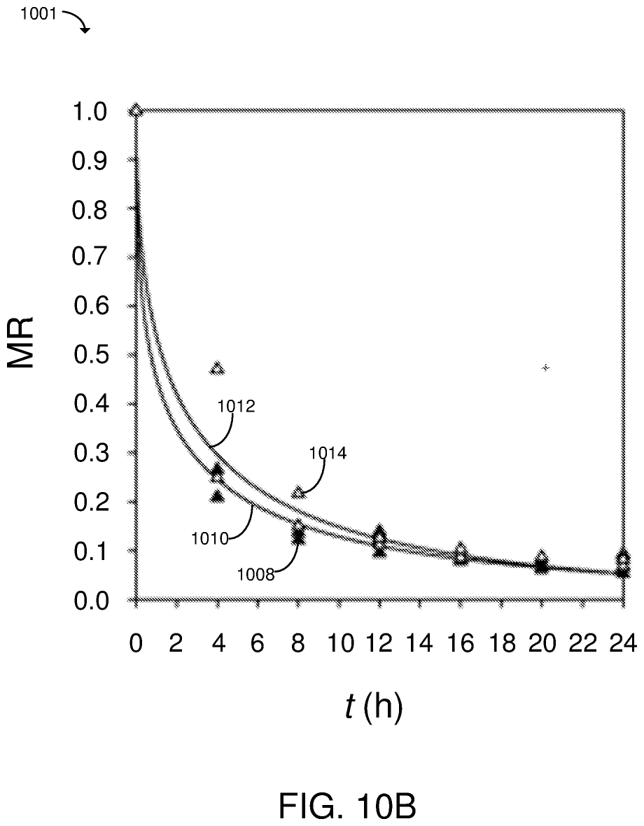

FIG. 12 is a graphical representation of results of an embodiment of a method of UV-A light dehydration of food depicting enthalpies of starch gelatinization in accordance with the present disclosure. For example, FIG. 12 includes a graph 1200 of enthalpies of starch gelatinization as a function of the Moisture Content Dry Basis (M. C. D. B., kg_{Water}/kg_{Dry solids}) resulting from methods 1600 and/or 1700. FIG. 12 shows data points 1202 representing enthalpy as a function of MCDB of the samples of purple potato discussed in connection with FIGS. 6A-B and 11. The linear trend 1204 suggests that even under storage at high levels of RH, purple potatoes dehydrated according to examples of the present disclosure are not able to regain enough moisture to disturb the structure of their starch and reduce the thermal energy required to induce their gelatinization. Thus, the linear trend 1204 of FIG. 12 shows that the examples described herein result can improve preservation of the chemical integrity of dehydrated food products even upon extended storage and under a wide range of relative humidities.

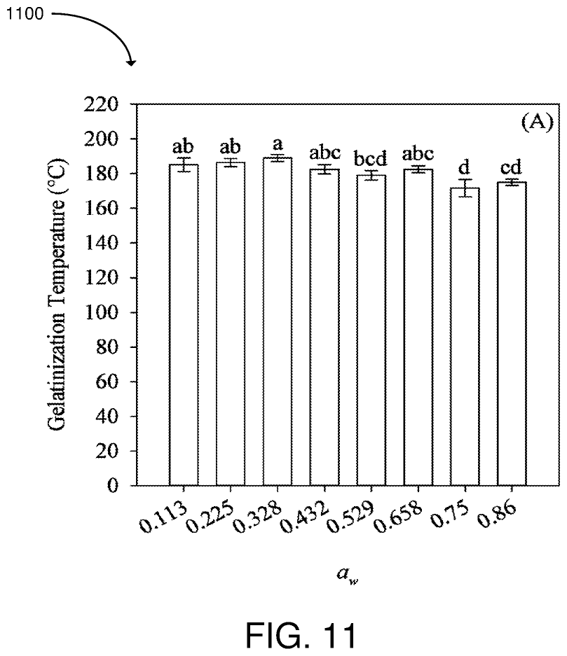

FIG. 13 is a graphical representation of results of an embodiment of a method of UV-A light dehydration of food depicting heat flow and starch gelatinization temperatures in accordance with the present disclosure. FIG. 13 includes a graph 1300 of results of an embodiment of a method of UV-A light dehydration of food in accordance with the present disclosure, such as methods 1600 and 1700. The starch gelatinization temperature values illustrated in FIG. 11 can be grouped in three a_{w} (water activity) ranges in which the starch gelatinization temperature is not significantly different (P>0.05): low (0.113≤a_{w}≤0.328), intermediate (0.432≤a_{w}≤0.658), and high (0.75≤a_{w}≤0.86).

Graph 1300 shows representative thermograms of the starch gelatinization temperatures at high 1302, medium 1304, and low 1306 a_{w}.

FIG. 14 is a schematic diagram of an apparatus 1400 for UV-A light dehydration of food in accordance with the present disclosure. The apparatus 1400 includes a controller 112 that includes a food moisture module 1434, a light source module 1430, and an air flow module 1432, which are described below. In some examples, all or a portion of the apparatus 1400 is implemented with hardware circuits. In other examples, all or a portion of the apparatus 1400 is implemented using a programmable hardware device. In other examples, all or a portion of the apparatus 1400 is implemented with executable code stored on computer readable storage media where the code is executable by a processor, such as a processor in the controller 112.

The light source module 1430 is configured to expose one or more pieces of food in a chamber (e.g., food 104 in chamber 106 in FIG. 1) to UV-A light (e.g., through light source 102) to dehydrate the one or more pieces of food. In some examples, the light source module 1430 is configured to actuate turning on and/or increasing the intensity of a UV-A light source.

The apparatus 1400 includes an air flow module 1432 electrically and/or communicably coupled to an air flow source (e.g., air mover 210 of FIG. 2). The air flow source is configured to provide air flow in a chamber (e.g., chamber 106 ) across the pieces of food while they are being exposed to the UV-A light. In some examples, the air flow has a relative humidity of less than 50 percent.

The food moisture module 1434 is configured to remove the one or more pieces of food from being exposed to the UV-A light and air flow in response to moisture in the one or more pieces of food being below a certain threshold. For example, the food moisture module 1434 determines that a moisture of the food has fallen below a certain level and communicates with the light source module and/or the air flow module to remove the food from being exposed to the UV-A light and air flow. In some examples, the light source module 1430 is configured to turn off and/or decrease the intensity of the UV-A light source, thus removing the food from exposure to the UV-A light. Additionally, the air flow module 1432 is configured to stop and/or decrease air flow to the food. In some examples, the air flow module 1432 is configured to actuate turning down or turning off an air mover moving air across the food (e.g., air mover 210 of FIG. 2). In some examples, the light source module 1430 and/or the air flow module 1432 of the controller 112 are electrically coupled to the UV-A light source and/or to the air mover. In other examples, the light source module 1430 and/or the air flow module 1432 of the controller 112 are only communicably coupled to the UV-A light source and/or to the air mover.

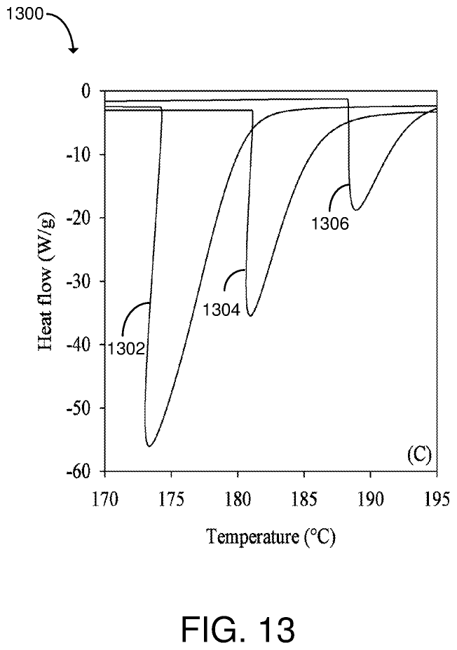

FIG. 15 is a schematic diagram of an embodiment of a controller apparatus 1500 for UV-A light dehydration of food including an air flow moisture module 1536 and a mass module 1538, in accordance with the present disclosure. The apparatus 1500 includes a controller 112 with a light source module 1430, an air flow module 1432, and a food moisture module 1434 which are substantially similar to those described above in relation to the apparatus 1400 of FIG. 14. In various examples, the food moisture module 1434 includes an air flow moisture module 1536 and/or a mass module 1538, which are described below. In some examples, all or a portion of the apparatus 1500 of FIG. 15 is implemented similarly to the apparatus 1400 of FIG. 14.

The food moisture module 1434 includes an air flow moisture module 1536 and/or a mass module 1538. In some examples, the light source module 1430 is configured to turn on the UV-A light sources to expose food 104 to UV-A light from the UV-A light sources 102 and the air flow module 1432 is configured to initiate air flow by the air flow source at a beginning of dehydration cycle. The food moisture module 1434 is configured to remove the food 104 from being exposed to UV-A light and air flow by the light source module 1430 turning off the UV-A light sources 102 and the air flow module 1432 turning off the air flow source in response to moisture in the food 104 being below a moisture threshold.

In some examples, the air flow moisture module 1536 determines the moisture level in the air coming off of the food 104. In some examples, the air flow moisture module 1536 is in communication with a humidity sensor 416 sensing air flow from the food 104. Based on communication with the humidity sensor 416, the air flow moisture module 1536 determines that the moisture measured by the sensor indicates that the moisture of the food 104 is below a moisture threshold.

Additionally or alternatively, the mass module 1538 is configured to determine the mass of the food 104 (e.g., via a scale 418) and compare that mass to an initial mass of the food 104 (i.e., the mass at the beginning of the dehydration cycle). The food moisture module 1434 is configured, in some examples, to stop the food from being exposed to UV-A light and air flow in response to the mass module 1538 determining that the mass of the food 104 indicates that the moisture of the food 104 has fallen below a threshold moisture.

FIG. 16 is a flow chart of an embodiment of a method 1600 for UV-A light dehydration in accordance with the present disclosure. The method 1600 begins by exposing 1602, using a light source (e.g., light source 102), one or more pieces of food 104 in a chamber to UV-A light to dehydrate the one or more pieces of food 104. The method 1600 provides 1604, with an air flow source (e.g., air mover 210 of FIG. 2), 1604 air flow across the one or more pieces of food 104 in the chamber while the food 104 is exposed to the UV-A light. The air of the air flow has a relative humidity of less than 50 percent. Some examples include exposing the food to the UV-A light and the air flow until the food 104 has lost enough moisture. The method 1600 removes 1606, with a controller (e.g., controller 112), the one or more pieces of food 104 from being exposed to the UV-A light and air flow in response to the moisture in the one or more pieces of food 104 being below a moisture threshold. In some examples, the controller 112 removes the one or more pieces of food 104 from exposure to the UV-A light sources 102 and/or to the air flow in response to receiving an input signal. In various examples, all or a portion of the method 1600 is implemented with the light source module 1430, the air flow module 1432, and/or the food moisture module 1434.

FIG. 17 is a flow chart of another method 1700 of UV-A light dehydration of food (e.g., food 104) in accordance with an embodiment of the present disclosure. The method 1700 begins and reduces 1701 humidity of air flow. In some examples, the method 1700 reduces 1701 humidity of the air flow to a relative humidity of not greater than 35%. For example, the method 1700 reduces the relative humidity of air flow within an indoor environment, which thus reduces the relative humidity of air flowing into a chamber 106 containing food 104 through orifices 220, in some examples. In some examples, reducing 1701 the relative humidity of air flow across the food 104 includes reducing the relative humidity of air, with an air dryer and/or HVAC system, flowing in through an orifice 220 such that the air flow to the food is below a determined and/or pre-set relative humidity threshold.

The method 1700 turns on 1702 the UV-A light sources 102 and exposes 1704 the food 104 in a chamber 106 to the UV-A light of the sources 102 to dehydrate the food 104. For example, the food 104 is exposed when it is placed in proximity to the UV-A light sources 102. In some examples, the UV-A light has a wavelength in a range of 360 to 370 nm.

The method 1700 provides 1705 air flow across the food 104 while being exposed to the UV-A light. In some examples, the method 1700 includes initiating air flow by the air flow source at a beginning of a dehydration cycle. In some examples, the method 1700 provides 1705 the air flow at a rate of 18 to 22 liters per minute. In some examples, the air flow source includes a vacuum, a pump, and/or a fan. In some examples, providing 1705 air flow across the food includes pulling or sucking air from the chamber 106, such as with a vacuum air flow source.

The method 1700 determines 1706 a moisture content of the food 104. In some examples, the method 1700 determining 1706 a moisture content of air flow from the food includes determining a mass of the food 104. In the examples, as illustrated in and described in connection with FIG. 4, the food 104 can be weighed throughout the process to determine how much moisture has been lost. In other examples, the method 1700 determining 1706 the moisture content of the food 104 includes measuring the moisture content of air flowing off of the food 104. For example, one or more sensors 416 within proximity of the food 104 that measure the humidity of the air flow can provide this measurement. In the examples, the method 1700 determines 1706 that the moisture in the food 104 is below a threshold moisture by comparing the moisture measurements of the humidity sensor(s) to a moisture threshold. In other examples, the method 1700 determines that the moisture in the food 104 is below a moisture threshold by determining, using a mass sensor such as a scale 418, that a mass of the food 104 indicates that the moisture of the food 104 is below the moisture threshold.

The method 1700 removes 1708 the food 104 from exposure to the UV-A light in response to moisture in the food 104 being below a threshold moisture. For example, the method 1700 turns off the UV-A light sources 102, or removes the food 104 from the chamber(s) 106 and/or 408. The method 1700, in some examples, also includes removing 1708 the food from being exposed to the air flow. In such examples, removing 1708 the food the food from being exposed to the air flow further includes turning off the air flow sources.

In some examples, the method 1700 removing 1708 the food 104 from air flow and/or UV-A light exposure includes determining that moisture of a humidity sensor sensing air flow from the food indicates that the moisture of the food 104 is below a moisture threshold. In some examples, the method 1700 removing the food air flow and/or UV-A light exposure includes receiving input from a mass sensor, that a mass of the one or more pieces of food indicates that moisture of the one or more pieces of food is below the moisture threshold.

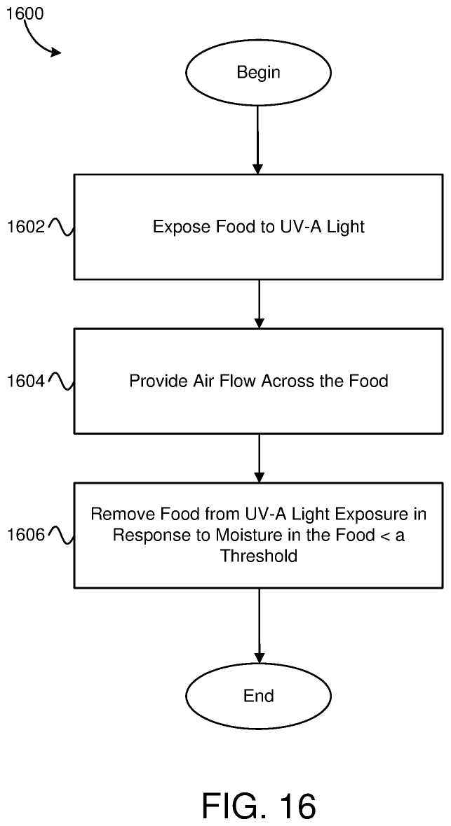

FIG. 18 is a graphical representation of results of an embodiment of a method of UV- A light dehydration of food depicting reduction of Escherichia coli (“E. coli”) population over time (h). For example, FIG. 18 is an illustration 1800 of results of methods 1600 and 1700 shown in FIGS. 16 and 17. Bars 1802 and 1806 represent E. coli population in a food sample dehydrated according to conventional methods (e.g., without exposing the food to UV-A light). Bars 1804 and 1808 represent E. coli population in a food sample dehydrated via exposure to UV-A light, as described herein. As shown in FIG. 18, examples of the present disclosure can help to decrease the presence of E. coli in a dehydrated food sample. For example, in FIG. 18, the E. coli population 1806 of the conventionally-dehydrated food is significantly higher than the E. coli population 1808 of the UV-A dehydrated sample after 10 hours of dehydration.

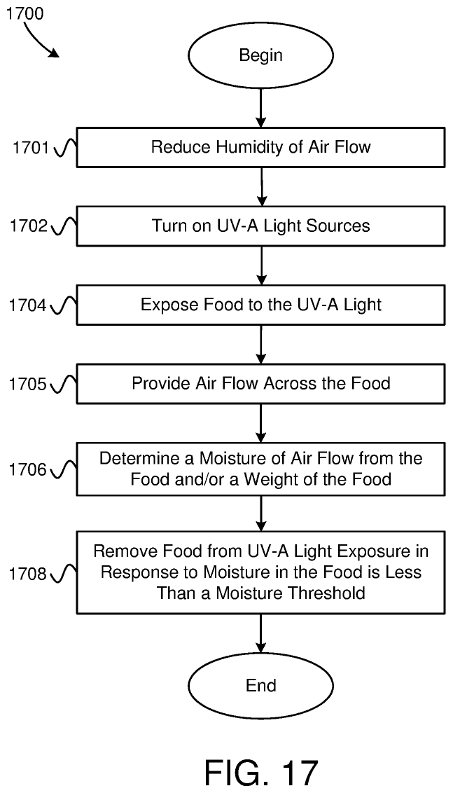

FIG. 19 is a graphical representation of results of an embodiment of a method of UV-A light dehydration of food depicting reduction of Listeria innocua population over time. For example, FIG. 19 is an illustration 1900 of results of methods 1600 and 1700 shown in FIGS. 16 and 17. Bars 1902 and 1906 represent Listeria innocua population in a food sample dehydrated according to conventional methods. Bars 1904 and 1908 represent Listeria innocua population in a food sample dehydrated via exposure to UV-A light, as described herein. As shown in FIG. 19, examples of the present disclosure can help to decrease the presence of Listeria innocua in a dehydrated food sample. For example, in FIG. 19, the Listeria innocua population 1906 of the conventionally-dehydrated food is significantly higher than the Listeria innocua population 1908 of the UV-A dehydrated sample after 10 hours of dehydration.

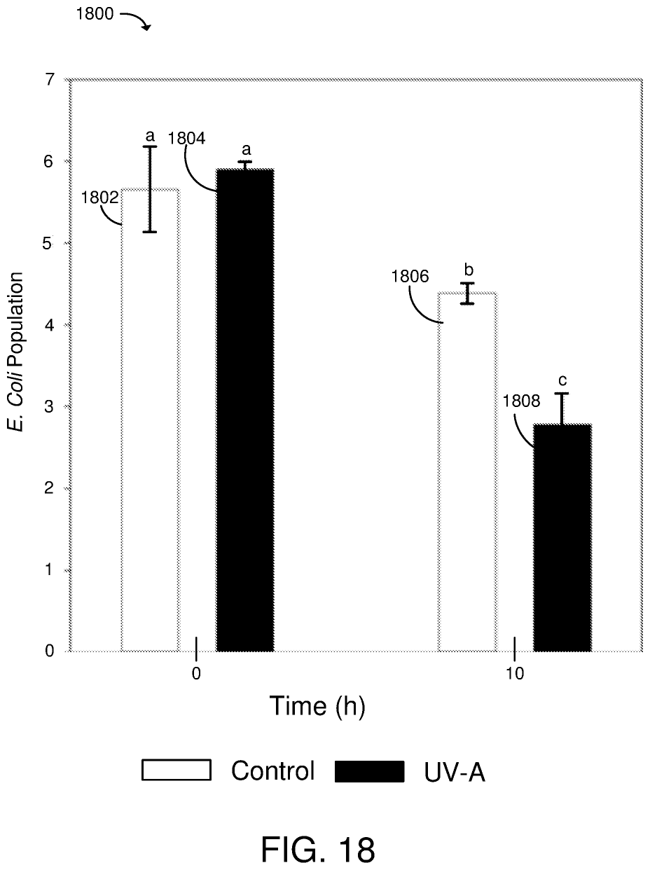

FIG. 20 is a graphical representation 2000 of results of an embodiment of a method of UV-A light dehydration of food depicting levels of Vitamin C in food. The graphical representation 2000 shows levels of Vitamin C in mango dehydrated using various methods. Bar 2002 illustrates levels of Vitamin C in fresh mango. Bar 2004 illustrates levels of Vitamin C in mango dehydrated using UV-A light, according to one or more examples of the present disclosure. Bar 2004 illustrates a level of Vitamin C of mango exposed to UV-A light for a period of approximately 10 hours, according to one or more examples of the present disclosure. Bar 2006 illustrates a level of Vitamin C in mango dehydrated using one or more examples of the present disclosure for approximately 10 hours without exposing the mango to UV-A light (e.g., using one or more components of the systems 200, 300, 400, and/or 500, such as pump 210 and/or air compressor 310). Bar 2008 illustrates a level of Vitamin C in mango dehydrated using hot air drying, such as hot air-drying at approximately 60° C. Bar 2010 illustrates a level of Vitamin C in mango dehydrated using a freeze drying method, such as freeze drying at approximately −40° C. and approximately 90 millitorrs (mTorr).

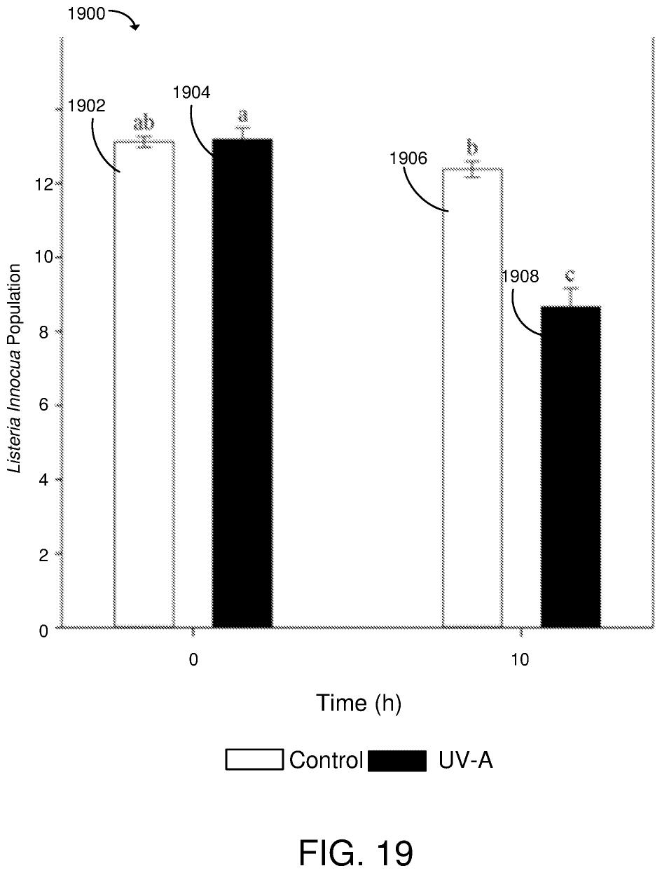

FIG. 21 is a graphical representation 2100 of results of an embodiment of a method of UV-A light dehydration of food depicting levels of retinol in food. The graphical representation 2100 shows levels of retinol in mango dehydrated using various methods. Bar 2102 illustrates levels of retinol in fresh mango. Bar 2104 illustrates levels of retinol in mango dehydrated using UV-A light, according to one or more examples of the present disclosure. Bar 2104 illustrates a level of retinol of mango exposed to UV-A light for a period of approximately 10 hours, according to one or more examples of the present disclosure. Bar 2106 illustrates a level of retinol in mango dehydrated using one or more examples of the present disclosure for approximately 10 hours without exposing the mango to UV-A light (e.g., using one or more components of the systems 200, 300, 400, and/or 500, such as pump 210 and/or air compressor 310). Bar 2108 illustrates a level of retinol in mango dehydrated using hot air drying, such as hot air-drying at approximately 60° C. Bar 2110 illustrates a level of retinol in mango dehydrated using a freeze drying method, such as freeze drying at approximately −40° C. and approximately 90 millitorrs (mTorr).

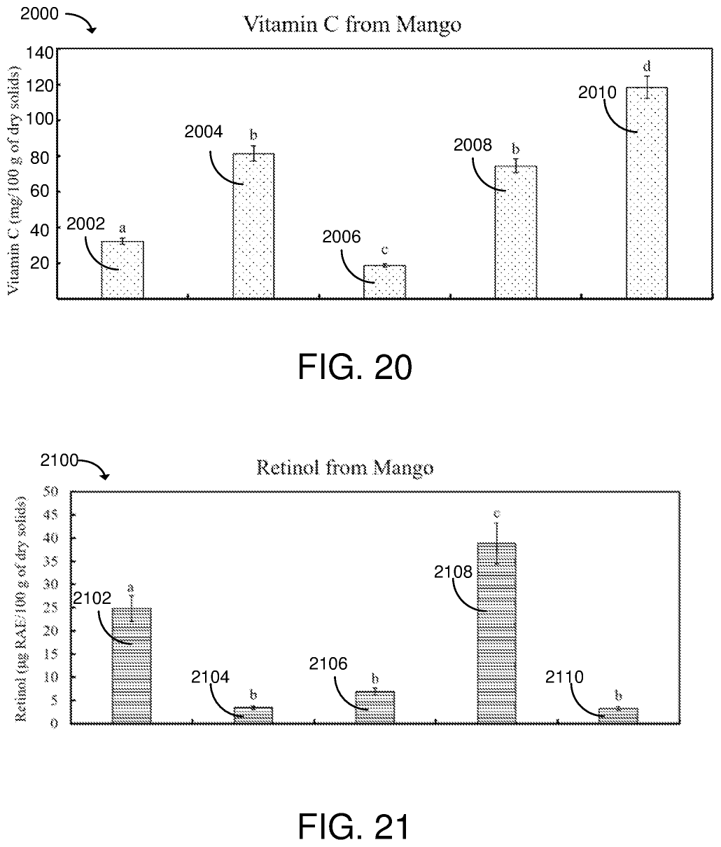

FIG. 22 is a graphical representation of results of an embodiment of a method of UV-A light dehydration of food depicting levels of beta carotene in food. The graphical representation 2200 shows levels of beta carotene in mango dehydrated using various methods. Bar 2202 illustrates levels of beta carotene in fresh mango. Bar 2204 illustrates levels of beta carotene in mango dehydrated using UV-A light, according to one or more examples of the present disclosure. Bar 2204 illustrates a level of beta carotene of mango exposed to UV-A light for a period of approximately 10 hours, according to one or more examples of the present disclosure. Bar 2206 illustrates a level of beta carotene in mango dehydrated using one or more examples of the present disclosure for approximately 10 hours without exposing the mango to UV-A light (e.g., using one or more components of the systems 200, 300, 400, and/or 500, such as pump 210 and/or air compressor 310). Bar 2208 illustrates a level of beta carotene in mango dehydrated using hot air drying, such as hot air-drying at approximately 60° C. Bar 2210 illustrates a level of beta carotene in mango dehydrated using a freeze drying method, such as freeze drying at approximately −40° C. and approximately 90 mTorr.

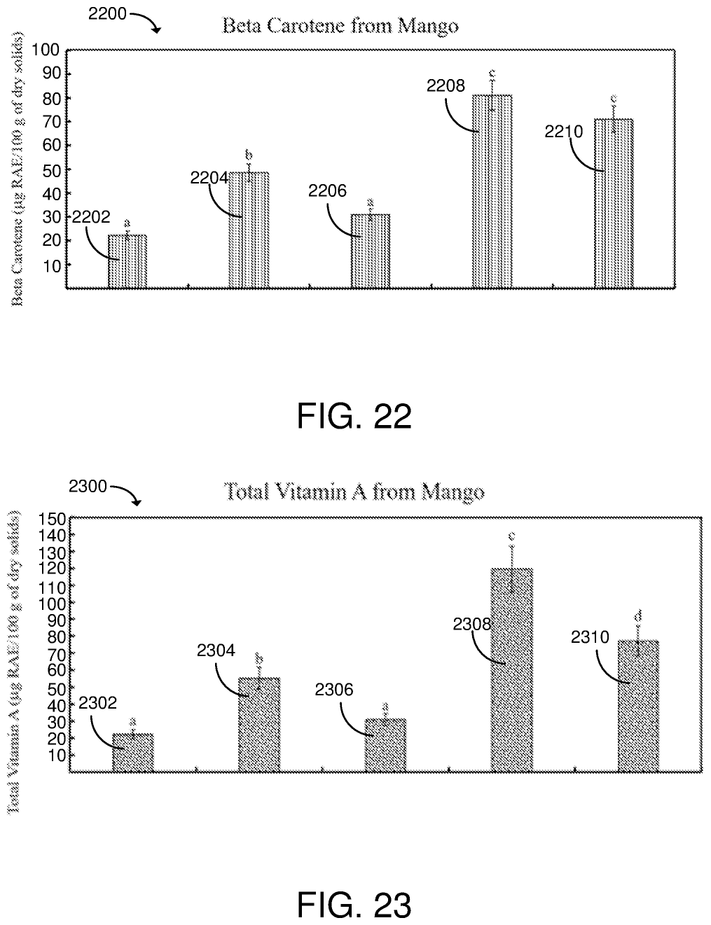

FIG. 23 is a graphical representation of results of an embodiment of a method of UV-A light dehydration of food depicting levels of Vitamin A in food. The graphical representation 2300 shows levels of Vitamin A in mango dehydrated using various methods. Bar 2302 illustrates levels of Vitamin A in fresh mango. Bar 2304 illustrates levels of Vitamin A in mango dehydrated using UV-A light, according to one or more examples of the present disclosure. Bar 2304 illustrates a level of Vitamin A of mango exposed to UV-A light for a period of approximately 10 hours, according to one or more examples of the present disclosure. Bar 2306 illustrates a level of Vitamin A in mango dehydrated using one or more examples of the present disclosure for approximately 10 hours without exposing the mango to UV-A light (e.g., using one or more components of the systems 200, 300, 400, and/or 500, such as pump 210 and/or air compressor 310). Bar 2308 illustrates a level of Vitamin A in mango dehydrated using hot air drying, such as hot air-drying at approximately 60° C. Bar 2310 illustrates a level of Vitamin A in mango dehydrated using a freeze drying method, such as freeze drying at approximately −40° C. and approximately 90 mTorr.

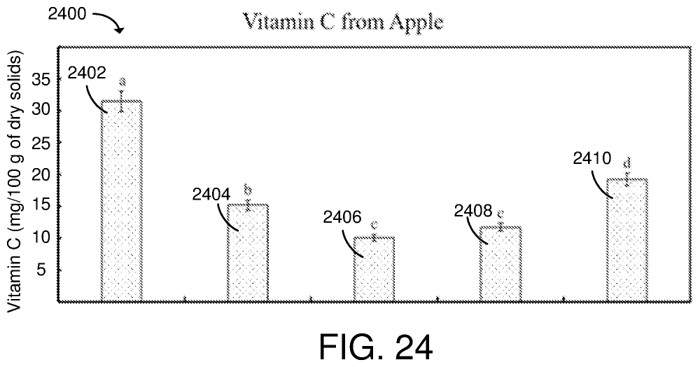

FIG. 24 is a graphical representation of results of an embodiment of a method of UV-A light dehydration of food depicting levels of Vitamin C in food. The graphical representation 2400 shows levels of Vitamin C in apple dehydrated using various methods. Bar 2402 illustrates levels of Vitamin C in fresh apple. Bar 2404 illustrates levels of Vitamin C in apple dehydrated using UV-A light, according to one or more examples of the present disclosure. Bar 2404 illustrates a level of Vitamin C of apple exposed to UV-A light for a period of approximately 10 hours, according to one or more examples of the present disclosure. Bar 2406 illustrates a level of Vitamin C in apple dehydrated using one or more examples of the present disclosure for approximately 10 hours without exposing the apple to UV-A light (e.g., using one or more components of the systems 200, 300, 400, and/or 500, such as pump 210 and/or air compressor 310). Bar 2408 illustrates a level of Vitamin C in apple dehydrated using hot air drying, such as hot air-drying at approximately 60° C. Bar 2410 illustrates a level of Vitamin C in apple dehydrated using a freeze-drying method, such as freeze drying at approximately −40° C. and approximately 90 mTorr.

The present invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a light source configured to expose one or more pieces of food in a chamber to ultraviolet (“UV”)-A light to dehydrate the one or more pieces of food;
an air flow source configured to provide air flow in the chamber across the one or more pieces of food while being exposed to the UV-A light, wherein air of the air flow has a relative humidity of less than 50 percent; and
a controller configured to remove the one or more pieces of food from being exposed to the UV-A light and air flow in response to moisture in the one or more pieces of food being below a moisture threshold.

2. The apparatus of claim 1, wherein the UV-A light has a wavelength in a range of 315 to 400 nanometers.

3. The apparatus of claim 2 wherein the UV-A light has a wavelength in a range of 360 to 370 nanometers.

4. The apparatus of claim 2, wherein the air flow has a relative humidity of not less than 11 percent and not greater than 35 percent.

5. The apparatus of claim 1, wherein the chamber comprises a first chamber and further comprising a second chamber within the first chamber, wherein the one or more pieces of food are positioned within the second chamber and the second chamber is transparent.

6. The apparatus of claim 1, wherein a distance between a surface on which the one or more pieces of food are positioned and the light source is between 10 and 20 centimeters.

7. The apparatus of claim 1, wherein the controller is further configured to turn on the light source to expose the one or more pieces of food to UV-A light from the light source and to initiate air flow by the air flow source at a beginning of a dehydration cycle and wherein the controller removing the one or more pieces of food from being exposed to the UV-A light and air flow comprises the controller turning off the light source and the air flow source in response to moisture in the one or more pieces of food being below the moisture threshold.

8. The apparatus of claim 1, wherein the controller removing the one or more pieces of food from being exposed to the UV-A light and air flow in response to moisture in the one or more pieces of food being below the moisture threshold comprises:
the controller determining that moisture of a humidity sensor sensing air flow from the one or more pieces of food indicates that the moisture of the one or more pieces of food is below the moisture threshold; and/or
the controller determining, using a mass sensor, that a mass of the one or more pieces of food indicates that moisture of the one or more pieces of food is below the moisture threshold.

9. The apparatus of claim 1, wherein the air flow source further comprises an air conditioner configured to reduce humidity of air flowing in an air flow inlet providing air to the one or more pieces of food to below a relative humidity threshold.

10. The apparatus of claim 1, wherein the air flow source provides the air flow at a rate between 10 and 100 liters per minute.

11. The apparatus of claim 1, wherein the air flow source comprises a vacuum, a pump, and/or a fan.

12. The apparatus of claim 1, wherein the air flow source is connected to an air flow inlet providing the air flow to the one or more pieces of food and/or an air flow outlet removing the air flow from the one or more pieces of food.

13. A method comprising:
exposing, using a light source, one or more pieces of food in a chamber to ultraviolet (“UV”)-A light to dehydrate the one or more pieces of food;
providing, with an air flow source, air flow across the one or more pieces of food in the chamber while being exposed to the UV-A light, wherein air of the air flow has a relative humidity of less than 50 percent; and
removing the one or more pieces of food from being exposed to the UV-A light and air flow in response to moisture in the one or more pieces of food being below a moisture threshold.

14. The method of claim 13, wherein the UV-A light has a wavelength in a range of 360 to 370 nanometers.

15. The method of claim 13, further comprising, with a controller, turning on the light source to expose one or more pieces of food to UV-A light from the light source and initiating air flow by the air flow source at a beginning of a dehydration cycle and wherein removing, with the controller, the one or more pieces of food from being exposed to the UV-A light and air flow comprises, with the controller, turning off the light source and the air flow source in response to moisture in the one or more pieces of food being below the moisture threshold.

16. The method of claim 13, wherein removing, the one or more pieces of food from being exposed to the UV-A light and air flow in response to moisture in the one or more pieces of food being below the moisture threshold comprises:
determining, with a controller, that moisture of a humidity sensor sensing air flow from the one or more pieces of food indicates that a moisture of the one or more pieces of food is below the moisture threshold; and/or
determining, with a controller receiving input from a mass sensor, that a mass of the one or more pieces of food indicates that moisture of the one or more pieces of food is below the moisture threshold.

17. The method of claim 13, further comprising reducing humidity of air flowing in an air flow inlet providing air to the one or more pieces of food to below a humidity threshold.

18. The method of claim 13, wherein providing the air flow comprises providing the air flow at a rate of 10 to 100 liters per minute.

19. The method of claim 13, wherein the air flow source comprises a vacuum, a pump, and/or a fan.

20. A system comprising:
a chamber having:
a light source comprising one or more ultraviolet (“UV”)-A lights an air flow inlet; and
an air flow outlet;
an air flow source connected to the air flow inlet and/or the air flow outlet, the air flow source comprising an air mover positioned to provide air flow to the at least one of the air flow inlet or the air flow outlet, wherein air provided by the air flow source comprises a relative humidity of less than 50 percent; and
a controller configured to:
turn on the light source to expose one or more pieces of food to UV-A light from the light source;
turn on the air mover to provide air flow across the one or more pieces of food, wherein air exits the chamber via the air flow outlet; and
turn off the light source and the air mover in response to moisture in the one or more pieces of food being below a moisture threshold.
